(19) United States
(12) Patent Application Publication
(10) Pub. No.: US 2007/0151748 A1
(43) Pub. Date: Jul. 5, 2007

(54) Flexible carrier with an electrically conducting structure

(76) Inventors: Andreas Ziegler, Stetten (CH); Norman Door, Steisslingen (DE); Werner Hammon, Stockach (DE); Markus Luthi, Marthalen (CH)

Correspondence Address: Fisher Christen & Sabol, 1725 K Street NW, Suite 1108, Washington, DC, 20006, US

(21) Appl. No.: 10/584,906

(22) PCT Filed: Dec. 17, 2004
(86) PCT No.: PCT/EP04/14390

§ 371 Date: Jun. 28, 2006

(30) Foreign Application Priority Data
Jan. 5, 2004 (EP) 04405004.5

(51) Int. Cl. H01B 7/08

(52) U.S. Cl. 174/117 FF

(57) ABSTRACT

A flexible carrier (10) having a base layer made of plastic and at least one conducting structure (20) which is impressed at least on the base layer (12) with an electrically conductive paint on one side thereof. The at least one electrically conducting layer (20) is arranged between the base layer (12), and at least one covering layer (14) made of plastic and each of the optionally other electrically conducting structures (22) are respectively arranged between two successive other covering layers. The base layer (12) is connected to the at least one covering layer (14) and each of the optionally other covering layers is connected to the adjacent covering layers.

The invention relates to a flexible substrate with a base layer of plastic and at least one electrically conductive structure printed at least on one side of the base layer using electrically conductive ink and a process for continuously printing the electrically conductive structure on the flexible substrate.

Known in the past was a process for producing printed circuits or printer circuit boards in which the switching system or the electrical circuit is printed directly using an electrically conductive ink positively on an non-electrically conductive plastic board so that the printing ink performs the function of insulated wires. Among the known electrically conductive inks are the so-called silver paints which are printed on the boards using screen printing. For that purpose, fine silver powder is mixed into the screen printing ink until the desired electrical conductivity is achieved.

Also known are sensors made up of layers of films superimposed on each other. These are made e.g. of a polyester film forming the base material onto which a resistance body of electrically conductive resistance material is deposited using the screen printing method. A distance from this base film is an elastic top film e.g. of polyoxymethylene which is likewise coated with an electrically conductive material as counter electrode and, is held by means of spacers a small distance from the resistance body.

Known from EP-B-0 129 785 is a film-type packaging serving as a container for medicaments having a conductive circuit deposited on the film for making electrical contact with a signal emitter. The arrangement serves to check the consumption of the medicament by a patient.

The object of the invention is to provide a flexible substrate of the kind mentioned at the start which can be produced in a simple and cost-favourable manner. A further objective of the invention is the creation of a flexible substrate in the form of a flat strip-type cable which is resistant to the influence of weathering. According to another objective the flat strip-type cable should offer the advantages of a conventional electrical cable with twisted conductors and/or with electromagnetic screening.

These objectives are achieved by way of the invention in that the, at least one, electrically conductive structure is provided between the base layer and at least one top layer of plastic and each of the possible subsequent further electrically conductive structures between pairs of subsequent further top layers, and the base layer is joined to at least one top layer and each of the possible further top layers to the neighbouring top layers.

A preferred version of the flexible substrate according to the invention is such that the, at least one, top layer exhibits at least one further electrically conductive structure printed with electrically conductive ink on the, at least one, top layer and an electrically insulating intermediate layer of plastic is provided between each of the electrically conductive structures.

In a particularly useful version the, at least one, top layer with the, at least one, further electrically conductive structure is formed by the base layer with the electrically conductive structure folded at least once over itself.

Another preferred version is such that the flexible substrate is rolled up.

In a useful version of the flexible substrate as a flat strip-type cable the electrically conductive structures are multiply crossing conductors which, analogous to the known twisting of electrical wires, produces a reduction in electrical and magnetic fields.

The base layer and the, at least one, top layer or in the case of further top layers at least the top layer furthest removed from the base layer may each exhibit a barrier layer to prevent the passage of water vapour.

In principle all barrier layers that are suitable as barriers to water vapour may be employed for that purpose. Among the particularly preferred barrier layers are those layers that of at least one of the substances: aluminium, Al₂O₃ or SiOₓ where 0.9<x<2, in particular 1.2<x<1.8.

A particularly robust, flexible substrate that is impervious to water vapour and exhibits electromagnetic screening properties exhibits a barrier layer in the form of an aluminium foil which is bonded to the base layer and at least one top layer or, in the case of further top layers, at least to the top layer furthest removed from the base layer and is electrically insulated from the electrically conductive structure. Hereby, the aluminium foil may in principle be situated within a multi layer laminate. Preferred, however, is an arrangement in which the aluminium foil is situated on the outside of the base layer and on the top layer furthest removed from the base layer.

In principle, the production of the flexible substrate, the aluminium foil employed as a barrier layer may also form the substrate on which the base layer or top layer is deposited as a lacquer coating as a result of extrusion coating, whereby in the case of a lacquer layer a double lacquer coating is preferred.

Barrier layers may also be provided in the form of layers deposited in vacuum inside or on the outside of the base layer and the top layer.

Continuously printing the electrically conductive structure with electrically conductive ink on the plastic flexible substrate is preferably performed by photogravure printing. With particularly deeply etched or engraved photogravure printing cylinders, it is possible to produce a structure with good electrical conducting properties in only one single printing step. To increase the conductivity further, the structure may be printed over several times. Thereby, the edge of each printed structure is usefully set back somewhat with respect to the underlying structure so that on depositing an electrically insulating coating on the structure, a smooth transition is obtained between the base layer or top layer and the electrically conductive printing ink.

The water-tight, flexible substrate with electrically conductive structure which can be produced in a cost-favourable manner using the process according to the invention opens up a wide range of applications from high frequency power transfer with flat strip-type cables to heating mats for under-floor heating systems.

Further advantages, features and details of the invention are revealed in the following description of preferred exemplified embodiments and with the aid of the drawing which shows in

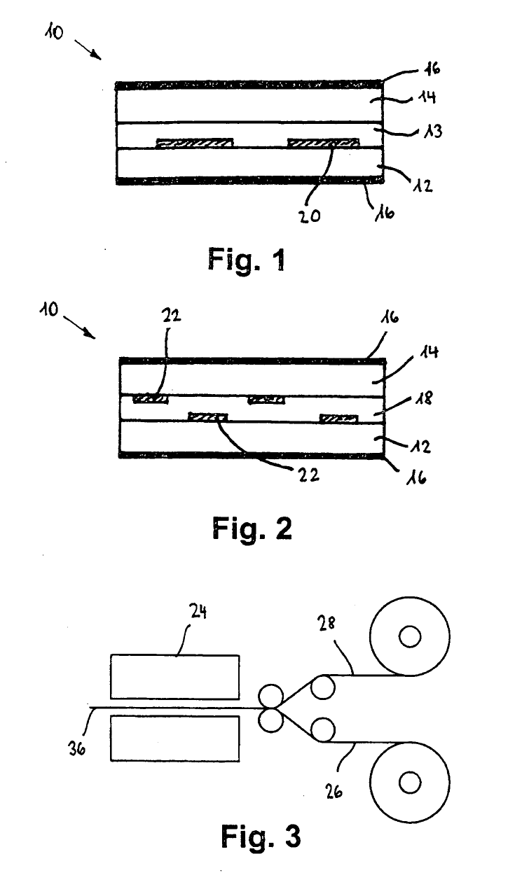

FIG. 1 a section through a first version of a flexible substrate with printed electrically conductive structure;

FIG. 2 a section through a second version of a flexible substrate with printed electrically conductive structure;

FIG. 3 a first process for continuous production of a flat strip-type cable with interweaving conductive strips;

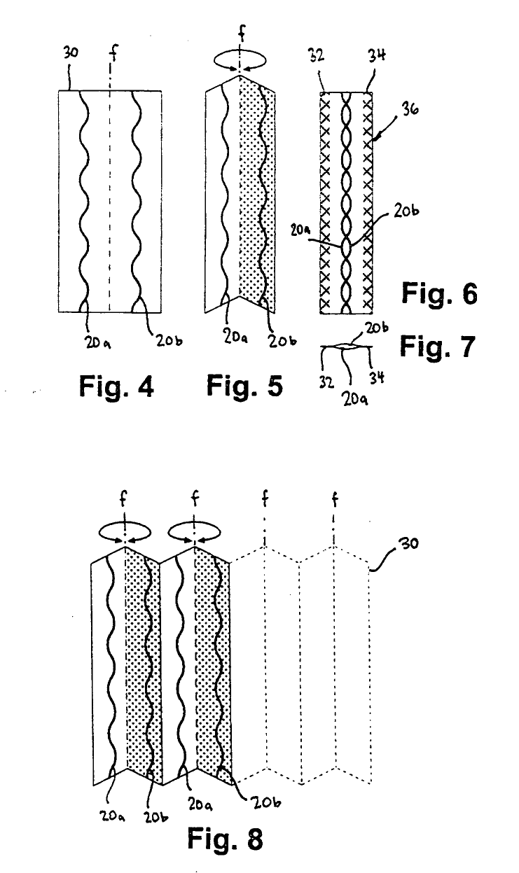

FIG. 4-6 a second process for continuous production of a flat strip-type cable with crossing conductive strips;

FIG. 7 cross-section through the flat strip-type cable in FIG. 6 along line I-I;

FIG. 8 a third process for continuous production of a flat strip-type cable with interweaving conductive strips;

FIG. 9 a perspective view of a rolled up flat strip-type cable;

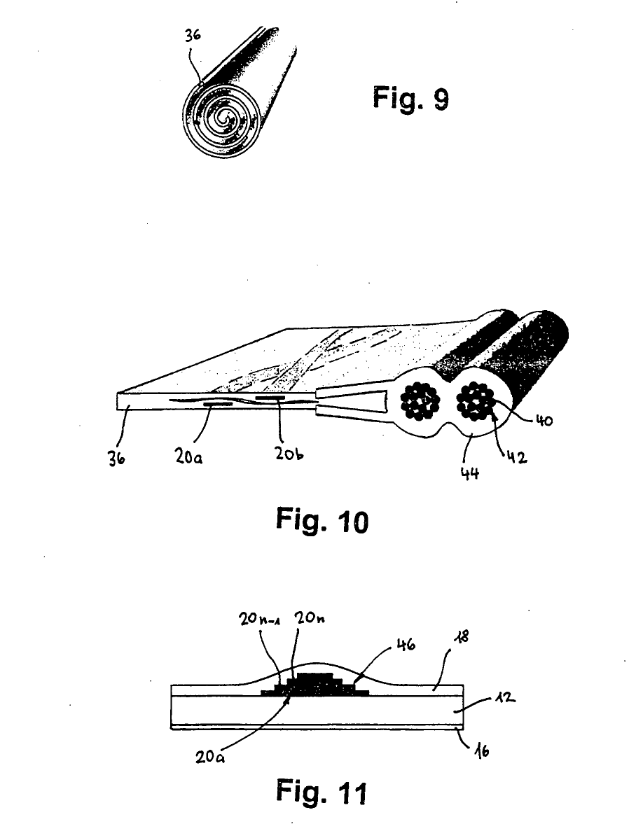

FIG. 10 cross section through a two strand electrical cable flat strip-type cables arranged thereon;

FIG. 11 section through a flat strip-type cable with multiple conductor strips printed over each other.

A first version of a flexible substrate 10 comprises, as shown in FIG. 1, a base layer 12, one side of which is bonded to a barrier layer 16 e.g. in the form of an aluminium foil, while the other side bears a printed electrically conductive structure 20 e.g. in the form of electrically conductive strips of electrically conductive ink. The printed side of the base layer 12 is joined to a top layer 14 e.g. of polyethylene via an intermediate layer 13 in the form of a permanent adhesive e.g. a polyurethane-based adhesive. The top layer 14 is likewise joined on the side away from the adhesive to a barrier layer 16 in the form of an aluminium foil. Both aluminium foils on the outside prevent water vapour from penetrating into the base layer 12, the top layer and into the intermediate layer and thus to the printed structure 20. At the same time, the outer lying aluminium foils provide electromagnetic screening for the electrically conductive structure 20 lying in between.

A second version of a flexible substrate 10 shown in FIG. 2 exhibits a base layer 12, e.g. of polyethylene, one side of which is joined to a barrier layer 16 e.g. in the form of an aluminium foil. Printed on the side of the base layer 12 not bonded to the barrier layer 16 is an electrically conductive structure 20 in the form of conductive strips of electrically conductive ink. Provided on the side of the base layer 12 bearing the electrically conductive structure 20 is an electrically insulating intermediate layer 18 made of plastic, e.g. polyethylene.

In the same manner as with the base layer 12, a top layer 14 e.g. of polyethylene with an aluminium foil acting as a barrier layer 16 is provided with a further electrically conductive structure 22. An intermediate layer 18 e.g. of an electrically insulating polyolefin-based adhesive is provided between the electrically conductive structure 20 on the base layer 12 and the further electrically conductive structure 22 on the top layer 14. Such a symmetrical substrate 10 can be made in a simple manner by folding the base layer 180° over itself along a line of symmetry so that the top layer 14 with the inner lying electrically conductive structure 22 and the outer lying aluminium foil is created from the base layer 12 with the inner lying electrically conductive structure 20 and the outer lying aluminium foil acting as barrier layer 16.

In addition to polyethylene and polypropylene, polyester is a particularly suitable material for the base layer 12 and the top layer 14.

In the process shown in FIG. 3 for manufacturing a flat strip-type cable 36 with multiple crossing conductor strips, a plastic film taken as the base layer 12 is first provided with a barrier layer 16, then a first electrically conductive strip 20a of electrically conductive ink printed on it then coated over by an insulating lacquer layer 18. In the same manner a second plastic film acting as top layer 14 is provided with a barrier layer 16 and a second conductive strip 20b printed onto it. Both strip-shaped materials 26, 28 are brought together in such a manner that the two conductive strips 20a and 20b face each other such that they continually cross over each other in the longitudinal direction of the material strips 26, 28. The film strips 26, 28 brought together in this manner are passed through a hot sealing facility 24 and sealed together forming longitudinal sealing seams at the edges of the strips of material 26, 28.

A foil of aluminium which is extrusion-bonded to the base layer 12 and top layer 14 is employed by way of preference as the barrier layer 16. Hot sealing of the base layer 12 bearing a barrier layer 16 and a first electrically conductive structure 20 to the top layer 14 bearing a barrier layer 16 and a second electrically conductive structure 22 may be performed e.g. via a separate plastic film that can be hot-sealed situated between the strips of material 26, 28.

Another version of a process for continuous production of a flat strip-type cable 36 is shown in FIGS. 4 to 7. First, as shown in FIG. 4, a strip of material 30 comprising a base layer 12 with a barrier layer 16 is produced and two conductive strips 20a, 20b printed thereon. The two conductive strips 20a, 20b are e.g. sinus-shaped wave-type lines of identical dimensions that are arranged on both sides of a folding axis f the same distance from that axis and parallel to each other. The conductive strips 20a, 20b printed on the strip of material 30 are then coated with a hot-sealable, electrically insulating e.g. polyolefin-based coating. This coated strip of material 30 with conductive strips 20a, 20b printed on it is, as shown in FIG. 5, then folded about the axis f such that, as shown in FIG. 7, the two conductive strips 20a, 20b lie over each other forming a regular double-wave pattern, repeatedly crossing-over each other. In the folded state the strip of material 30 passes through the hot-sealing facility 24 in FIG. 3 in which the edges of the folded strip of material 30 are continuously sealed together forming sealing seams 32, 34 at the edges of the folded material 30.

FIG. 8 shows a process for manufacturing a flat strip-type cable with a plurality of conductive strips 20a, 20b arranged over and repeatedly crossing each other based on the principle of the process shown in FIGS. 4 to 7. First a strip of material 30 comprising a base layer 12 with a barrier layer 16 is produced and a plurality of conductive strips 20a, 20b printed in pairs on it. The conductive strips 20a, 20b printed in pairs are—as shown in the example in FIG. 4—for example sinus-shaped wave-form lines of identical dimensions which are arranged parallel to each other on each side of, and the same distance from, a folding axis f. The conductive strips 20a, 20b printed onto the strip of material 30 are then coated with a hot-sealable, electrically conductive e.g. polyolefin-based coating. This coated strip of material 30 with printing is, as shown in FIG. 8, folded in a zigzag fashion about the folding axis f until all the pairs of conductive strips 20a, 20b lie over each other and cross each other repeatedly forming a regular double-wave pattern. The strip of material 30 is passed through the hot-sealing facility 24 in FIG. 3 in this multi-folded state, whereby the edges of the folded strip of material 30 are continuously sealed together forming sealing seams in the region of the folding axes.

Instead of multiple superposition of repeated criss-crossing conductive strips 20a, 20b to reduce disturbing electrical and magnetic fields, it is also possible to achieve multiple overlapping e.g. by rolling a flat strip-type cable as shown in FIG. 9.

In the example shown in FIG. 10 a flat strip-type cable 36 with multiple crossing conductive strips 20a, 20b is joined to a conventional two-strand power cable 38 with two power-carrying conductors 42 of single copper wires 40 and plastic sheathing 44. The conventional two-strand cable 38 is intended for very high currents, the two conductive strips 20a, 20b in the flat strip-type cable 36 is intended e.g. for steering control current in a bus-system.

In order to increase the electrical conductivity it may be necessary—as shown in FIG. 11—to print an electrical conductor strip that crosses itself many times. In order to ensure good cover of the conductive strip 20a with an electrically insulating coating, each conductive strip 20ₙ is slightly narrower than the previously deposited, underlying conductive strip 20ₙ₋₁, so that a strip-like edge 46 is formed that leads to a smoothed, uniform coating 18.

Although in the above examples the flat strip cables each exhibit only two conductive strips 20a, 20b, the present invention is not limited to the two examples shown; instead, it also embraces flat strip cables with a multiple of power carrying conductive strips, also of different diameter and material depending on the field of application.

1. A flexible substrate with a base layer (12) of plastic and at least one electrically conductive structure (20) printed with electrically conductive ink on one side of the base layer (12),
the at least one electrically conductive structure (20) between the base layer (12) and at least one top layer (14) of plastic and each of the possible further electrically conductive structures (22) is situated between each of the two further top layers, and the base layer (12) joined to the at least one top layer (14) and each of the possible further top layers with neighboring top layers.

2. The flexible substrate according to claim 1, wherein the at least one top layer (14) exhibits at least one further electrically conductive structure (22) printed with electrically conductive ink on the at least one top layer (14), and an electrically insulating intermediate layer (18) of plastic is provided between each of the electrically conductive structures (20, 22).

3. The flexible substrate according to claim 2, wherein the at least one top layer (14) is formed by the at least one further electrically conductive structure (22) of the base layer (12) with the electrically conductive structure (20) folded at least once over itself.

4. The flexible substrate according to claim 2, wherein the substrate is rolled up.

5. The flexible substrate according to claim 4, wherein the electrically conductive structures (20, 22) are conductive strips that cross each other many times.

6. The flexible substrate according to claim 5, wherein the at least one electrically conductive structure (20) comprises structure parts (20ₙ, 20ₙ₋₁) that are printed one over the other and each printed structure (20ₙ) is set back from the edge of the underlying printed structure (20ₙ₋₁) forming a step.

7. The flexible substrate according to claim 6, wherein the base layer (12) and the at least one top layer (14) or in the case of further top layers, at least the top layer furthest removed from the base layer (12) each exhibits a barrier layer (16) as barrier against penetration of water vapor.

8. The flexible substrate according to claim 7, wherein the barrier layer (16) exhibits a layer of at least one of the materials aluminium Al₂O₃ or SiOₓ with 0.9<x<2, in particular 1.2<x<1.8.

9. The flexible substrate according to claim 8, wherein the barrier layer (16) is an aluminium foil which is joined to the base layer (12) and the at least one top layer (14) or in the case of further top layers at least to the top layer furthest removed from the base layer (12) and is electrically separated from the electrically conductive structure (20).

10. The flexible substrate according to claim 9, wherein the aluminium foil is situated on the outside of the base layer (12) and on the outside of the top layer (14) furthest removed from the base layer (12).

11. The flexible substrate according to claim 8, wherein the barrier layer (16) is provided in the form of a layer deposited in vacuum inside or on the outside of the base layer (12) and the top layer (14).

12. A process for continuous printing electrically conductive structures (20, 22) with an electrically conductive ink on a flexible substrate (10) of plastic, wherein the substrate is printed using the gravure printing method, intaglio or rotogravure.

13. The process according to claim 12, wherein the electrically conductive structures (20, 22) are printed a number of times on top of each other a number of times in order to increase the electrical conductivity.

14. The process according to claim 13, wherein the edge of each printed structure (20ₙ) is set back from the edge of the underlying printed structure (20ₙ₋₁) thus forming a step.

15. The flexible substrate according to claim 1, wherein the substrate is rolled up.

16. The flexible substrate according to claim 2, wherein the electrically conductive structures (20, 22) are conductive strips that cross each other many times.

17. The flexible substrate according to claim 1 wherein the at least one electrically conductive structure (20) comprises structure parts (20ₙ, 20ₙ₋₁) that are printed one over the other and each printed structure (20ₙ) is set back from the edge of the underlying printed structure (20ₙ₋₁) forming a step.

18. The flexible substrate according to claim 1, wherein the base layer (12) and the at least one top layer (14) or in the case of further top layers, at least the top layer furthest removed from the base layer (12) each exhibits a barrier layer (16) as barrier against penetration of water vapor.

19. The flexible substrate according to claim 18, wherein the barrier layer (16) exhibits a layer of at least one of the materials aluminium Al₂O₃ or SiOₓ with 0.9<x<2, in particular 1.2<x<1.8.

20. The flexible substrate according to claim 19, wherein the barrier layer (16) is an aluminium foil which is joined to the base layer (12) and the at least one top layer (14) or in the case of further top layers at least to the top layer furthest removed from the base layer (12) and is electrically separated from the electrically conductive structure (20).

21. The flexible substrate according to claim 20, wherein the aluminium foil is situated on the outside of the base layer (12) and on the outside of the top layer (14) furthest removed from the base layer (12).

22. The flexible substrate according to claim 19, wherein the barrier layer (16) is provided in the form of a layer deposited in vacuum inside or on the outside of the base layer (12) and the top layer (14).
